(19) United States
(12) Patent Application Publication
(10) Pub. No.: US 2002/0185835 A1
(43) Pub. Date: Dec. 12, 2002

(54) Skateboard

(76) Inventor: Yi-Ling Wen, Fengyuan City (TW)

Correspondence Address: Alan D. Kamrath, Rider, Bennett, Egan & Arundel, LLP, Suite 2000, 333 South Seventh Street, Minneapolis, MN, 55402, US

(21) Appl. No.: 09/878,512

(22) Filed: Jun. 11, 2001

(51) Int. Cl. B62M 1/00; A63C 17/00

(52) U.S. Cl. 280/87.041

(57) ABSTRACT

A skateboard includes a wood-made base plate (10) and a graphite fiber-made resilient plate (20) to make the skateboard has excellent resilient and endurance. Additionally, the skateboard has the resilient plate (20) embedded inside so that the graphite fiber does not crack at edges to form sharp thorns to make users hurt.

### BACKGROUND OF THE INVENTION

1. Field of the Invention

The present invention relates to a skateboard, and more particularly to a skateboard having a base plate that is composed of multiple plates.

2. Description of Related Art

Skateboarding is quite popular among people as an exciting outdoor sport. Beginners skate on a plane area to enjoy the speed of running on the skateboard. Grand masters can jump and roll to soar up into the air or swing round and round between two highly curved towers. However, no matter which kind of skateboard they use, significant stresses occur in the base plate of the skateboard during use. Therefore, the base plates of the skateboards frequently fracture, especially when the base plate is made of wood only as the wood plate is not suitable for pressure treatment.

Other materials used in making the skateboard base plates include graphite fiber or glass fiber as these are endurable and light. But the graphite fiber skateboard or the glass fiber skateboard is easily cracked when the skateboard bumps at a front end or a rear end. Cracks are usually caused at these two ends and are sharp so that the users are easily injured during riding and even when simply carrying the skateboard by the base plate edge en route to a play area. Therefore, in order to overcome above-mentioned problems, the present invention has arisen to mitigate and/or obviate the disadvantages of the conventional skateboard.

### SUMMARY OF THE INVENTION

The main objective of the present invention is to provide a skateboard that is endurable and safe for skateboard players.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a skateboard in accordance with the present invention;

FIG. 2 is a side cross-sectional view of the skateboard in accordance with FIG. 1;

FIG. 3 is a side cross-sectional view of another embodiment of the skateboard; and

FIG. 4 is a side cross-sectional view of still another embodiment of the skateboard.

### DETAILED DESCRIPTION OF THE INVENTION

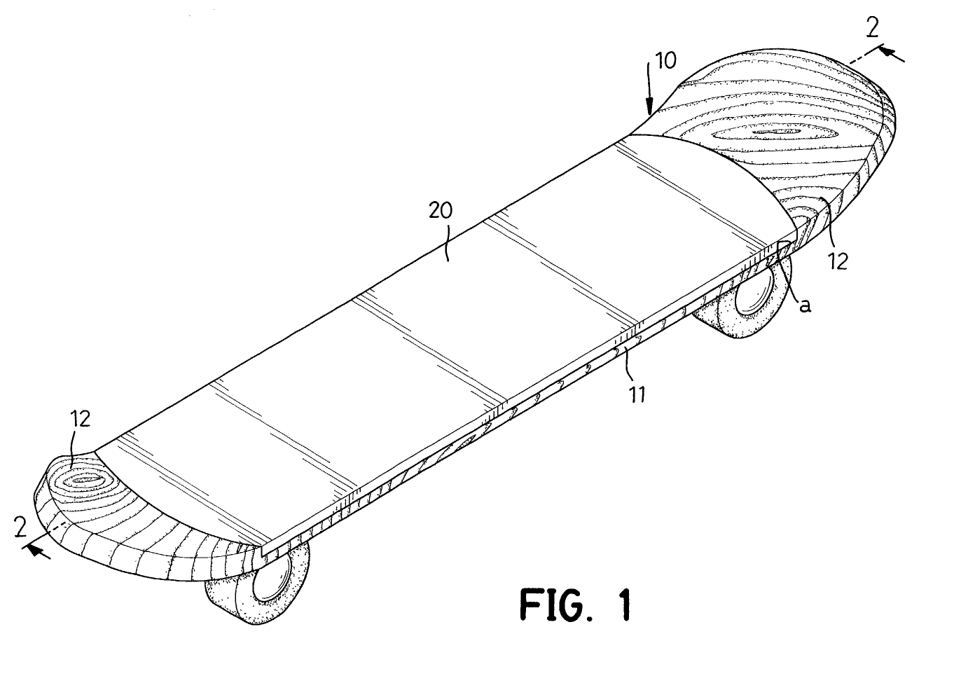

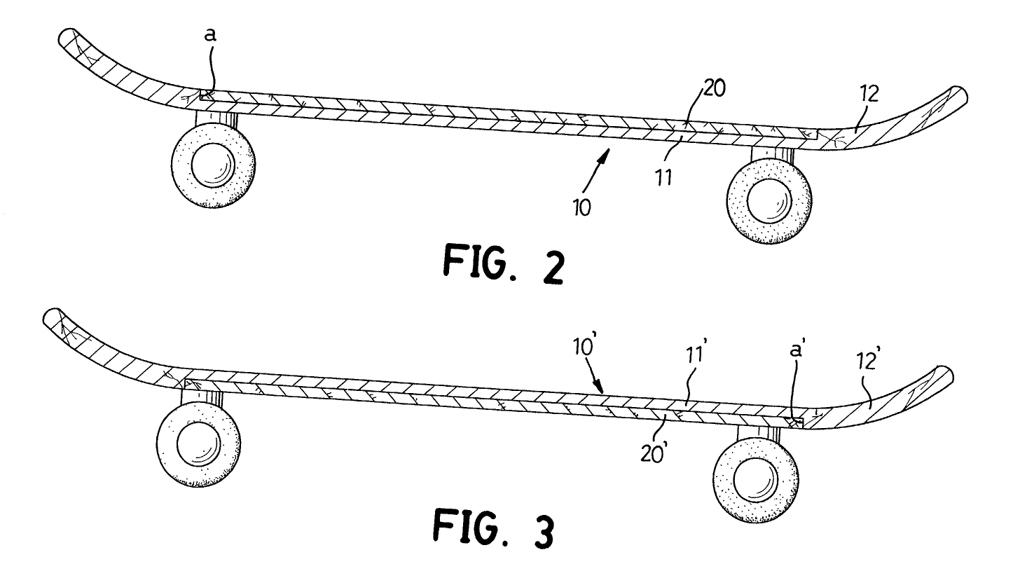

Referring to the drawings and initially to FIGS. 1 and 2, a first skateboard in accordance with the present invention in example comprises a base plate (10), a resilient plate (20), and multiple wheels (23).

The base plate (10) is made of a single piece of wood or plywood, and is divided into a middle portion (11) and two distal ends (12). The distal ends (12) are slightly raised and the middle portion (11) is thinner than the distal ends (12) to form a notch (a) on the base plate (10). The base plate (10) is trimmed to make surfaces of the base plate (10) smooth to avoid users getting hurt when they touch the surface of the skateboard. Additionally, the base plate (10) does not have jagged edges after crashing as occurs with a graphite base plateskateboard, which highlights this skateboard is safe.

The resilient plate (20) is made of a compound fiber such as graphite fiber or glass fiber and received in the notch (a) of the base plate (10) so as to make the skateboard endurable and prevent fracturing at the middle portion (11) of the base plate (10). Therefore, the middle portion (11), which is subject to high stress more often than other parts of the skateboard, is enhanced in resilience and endurance to ensure a user's safety.

The multiple wheels are secured under the base plate (10) at a front part and a rear part.

With reference to FIG. 3, a second skateboard in an embodiment similar to the aforementioned first skateboard in FIGS. 1 and 2 is shown, wherein the base plate (10′) is divided into a middle portion (11′) and two distal ends (12′). The middle portion (11′) is thinner than the two distal ends (12′), but the notch (a′) of the base plate (10′) is defined in a bottom face of the base plate (10′) to receive the resilient plate (20′) therein. The second skateboard has the same advantages in resilience and endurance with the first skateboard.

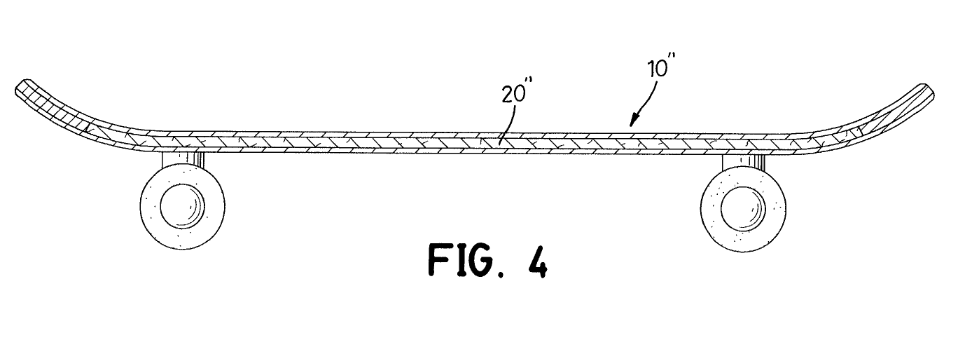

A third skateboard shown in FIG. 4 is composed of a resilient plate (20″) and the resilient plate (20″) is surrounded by multiple base plates (10″) at a top face, a bottom face, a front edge, and a rear edge. Therefore, the whole third skateboard has excellent endurance and jagged edges will not form the periphery of the third skateboard to avoid injuring users.

Although the invention has been explained in relation to its preferred embodiment, it is to be understood that many other possible modifications and variations can be made without departing from the spirit and scope of the invention as hereinafter claimed.

What is claimed is:

1. A skateboard comprising:
a base plate (10);
a resilient plate (20) made of compound materials and received in a middle portion of the base plate (10); and
a plurality of wheels rotatably mounted under the base plate (10).

2. The skateboard as claimed in claim 1, wherein the resilient plate (20) is embedded in the base plate (10) on a top face of the base plate (10).

3. The skateboard as claimed in claim 1, wherein the resilient plate (20) is embedded in the base plate (10) on a bottom face of the base plate (10).

4. The skateboard as claimed in claim 1, wherein the resilient plate (20) is enclosed by the base plate (10).

5. The skateboard as claimed in claim 1, wherein the base plate (10) is made of a single piece of wood.

6. The skateboard as claimed in claim 1, wherein the base plate (10) is made of plywood.

7. The skateboard as claimed in claim 1, wherein the resilient plate (20) is made of graphite fiber.

8. The skateboard as claimed in claim 1, wherein the resilient plate (20) is made of glass fiber.
